(19) United States
(12) Patent Application Publication
(10) Pub. No.: US 2025/0240356 A1
(43) Pub. Date: Jul. 24, 2025

(54) SYSTEMS AND METHODS FOR DETECTING SIGNAL AND SIGNALING TYPE

(71) Applicant: Cirrus Logic International Semiconductor Ltd., Edinburgh (GB)

(72) Inventors: Nathan Daniel Pozniak BUCHANAN, Austin, TX (US); Jing BAI, Austin, TX (US); Xin ZHAO, Austin, TX (US); Jeffrey SKARZYNSKI, Austin, TX (US); Wai-Shun SHUM, Austin, TX (US)

(73) Assignee: Cirrus Logic International Semiconductor Ltd., Edinburgh (GB)

(21) Appl. No.: 18/417,476

(22) Filed: Jan. 19, 2024

(51) Int. Cl. H04L 69/18; H04L 12/12; H04L 69/28

(52) U.S. Cl. CPC H04L 69/18; H04L 12/12; H04L 69/28

(57) ABSTRACT

A device may include a processor and a physical interface communicatively coupled to the processor and configured to communicatively couple to a second device via a wired communication link having a communications protocol comprising a plurality of signaling types, and further configured to detect a presence or absence of signaling on the wired communication link based on one or more signal properties of a signal on the wired communication link, and detect a signaling type, from the plurality of signaling types, of signaling on the wired communication link based on one or more signal properties of the signal on the wired communication link.

### FIELD OF DISCLOSURE

The present disclosure relates in general to systems for transmitting data among two or more devices linked together via a communications link, and in particular the detection of a signal on the communications link and detection of a signaling type (e.g., differential or single-ended) of the detected signal.

### BACKGROUND

In data transmission, network units (e.g., packets, frames, datagrams, etc.) are typically transmitted in sequential order from one device to another device, in a point-to-point network or in a multi-drop bus topology. In a communications link supporting two signaling modes (e.g., single-ended and differential), it may be necessary for a device to detect both the presence of a signal on the communications link (e.g., in order to wake up the device from an idle state) and the signaling type used for the signal. Many traditional communications networks do not enable detection of both signal presence and signaling type.

### SUMMARY

In accordance with the teachings of the present disclosure, the disadvantages and problems associated with detection of signal presence and signaling type in a communications link may be reduced or eliminated.

In accordance with embodiments of the present disclosure, a device may include a processor and a physical interface communicatively coupled to the processor and configured to communicatively couple to a second device via a wired communication link having a communications protocol comprising a plurality of signaling types, and further configured to detect a presence or absence of signaling on the wired communication link based on one or more signal properties of a signal on the wired communication link, and detect a signaling type, from the plurality of signaling types, of signaling on the wired communication link based on one or more signal properties of the signal on the wired communication link.

In accordance with these and other embodiments of the present disclosure, a method may include based on one or more signal properties of a signal on a wired communication link, detecting a presence or absence of signaling on the wired communication link having a communications protocol comprising a plurality of signaling types and detecting a signaling type, from the plurality of signaling types, of signaling on the wired communication link based on one or more signal properties of the signal on the wired communication link.

Technical advantages of the present disclosure may be readily apparent to one having ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example system for transmission of data, in accordance with embodiments of the present disclosure;

FIG. 2 illustrates a block diagram of selected components of an example physical interface of a device, in accordance with embodiments of the present disclosure;

FIG. 3A illustrates an example waveform of voltage versus time on a signal line in the absence of a signal on the signal line, in accordance with embodiments of the present disclosure;

FIG. 3B illustrates an example waveform of voltage versus time on a signal line in the presence of a differential signal on the signal line, in accordance with embodiments of the present disclosure;

FIG. 3C illustrates an example waveform of voltage versus time on a signal line in the presence of a single-ended signal on the signal line, in accordance with embodiments of the present disclosure;

FIG. 4 illustrates a block diagram of an example subsystem for detection of signal presence and signaling type, in accordance with embodiments of the present disclosure;

FIG. 5 illustrates a circuit diagram of an example comparator for detection of signal presence, in accordance with embodiments of the present disclosure; and

FIG. 6 illustrates a block diagram of an example long run gray counter synchronizer, in accordance with embodiments of the present disclosure.

### DETAILED DESCRIPTION

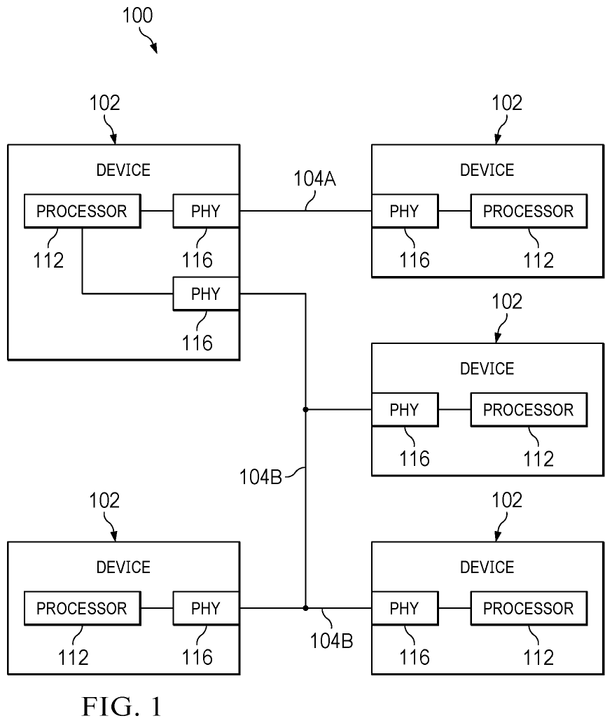

FIG. 1 illustrates a block diagram of selected components of an example system 100 comprising multiple devices 102 coupled to one another either by a point-to-point digital communications link 104A or a multi-drop bus digital communications link 104B, in accordance with embodiments of the present disclosure. As shown in FIG. 1, each device 102 may include its own processor 112 and at least one physical interface (PHY) 116. A processor 112 may include any suitable processing device, including without limitation a microprocessor, application-specific integrated circuit, digital signal processor, etc., configured to execute the functionality of a device 102. A PHY 116 may serve as a transmitter/receiver or transceiver for transmitting digital network units (e.g., packets, frames, datagrams) onto digital communications link 104 and for receiving digital network units from digital communications link 104 (e.g., for processing by processor 112).

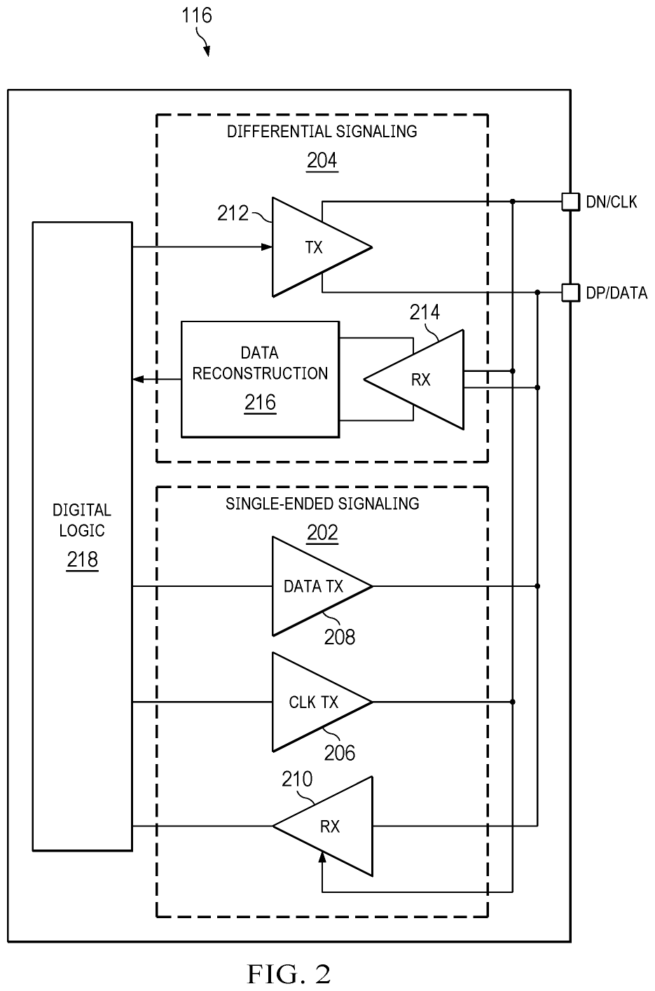

FIG. 2 illustrates a block diagram of selected components of an example PHY 116, in accordance with embodiments of the present disclosure. As shown in FIG. 2, PHY 116 may include a single-ended signaling block 202 and a differential signaling block 204. Single-ended signaling block 202 may include a clock transmitter 206 configured to transmit a clock on a signal line DN/CLK, a data transmitter 208 configured to transmit a data signal on a signal line DP/DATA, and a receiver 210 configured to receive data on signal line DP/DATA which is clocked by the clock signal generated by clock transmitter 206. Differential signaling block 204 may include a transmitter 212 configured to transmit a differential signal on signal lines DN/CLK and DN/DATA, a receiver 214 configured to receive a differential signal on signal lines DN/CLK and DN/DATA, and a data reconstruction block 216 configured to recover the received differential signal. PHY 116 may also include a digital logic block 218, which may interface with processor 112, to process and/or control signaling by the various components of PHY 116.

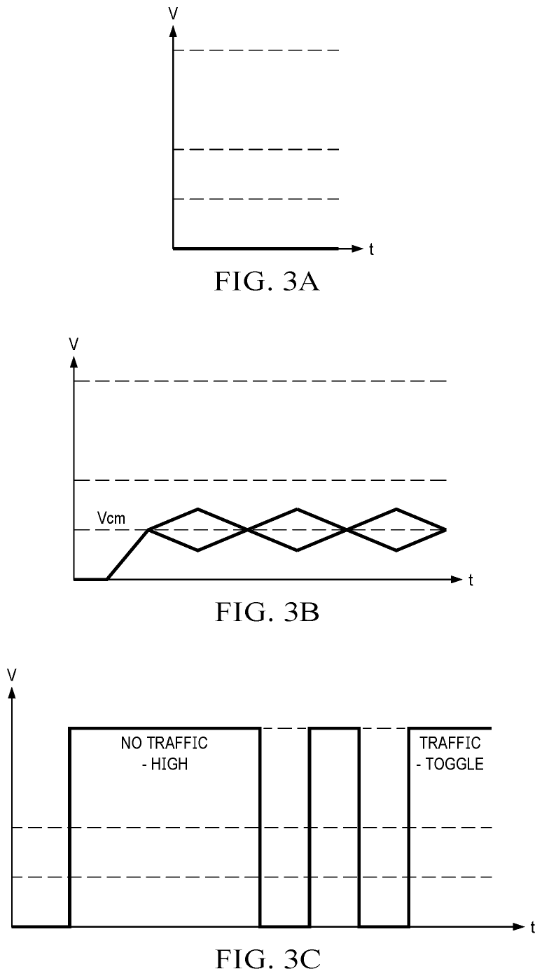

FIG. 3A illustrates an example waveform of voltage versus time on a signal line (e.g., signal line DN/CLK) in the absence of a signal on the signal line, in accordance with embodiments of the present disclosure. As shown in FIG. 3A, in the absence of a signal, a voltage on the signal line may remain at a constant zero or near-zero voltage.

FIG. 3B illustrates an example waveform of voltage versus time on a signal line (e.g., signal line DN/CLK) in the presence of a differential signal on the signal line, in accordance with embodiments of the present disclosure. As shown in FIG. 3B, with a differential signal, a voltage on the signal line may vary between a maximum and minimum voltage centered at a common-mode voltage V_{CM}.

FIG. 3C illustrates an example waveform of voltage versus time on a signal line (e.g., signal line DN/CLK) in the presence of a single-ended signal on the signal line, in accordance with embodiments of the present disclosure. As shown in FIG. 3C, with a single-ended signal, a voltage on the signal line may be a clock signal that may be at a constant high voltage (significantly higher than a common-mode voltage V_{CM}) when no traffic is communicated and may oscillate (e.g., for at least a minimum number of clock cycles at a known range of frequencies) when traffic is communicated.

In operation, and as described in greater detail below, a PHY 116 or a component thereof (e.g., logic within receiver 210 and/or receiver 214) may be configured to, based on the voltage on a signal line (e.g., signal line DN/CLK), determine whether a signal is present on a communications link and the signaling type (e.g., single-ended or differential) of the signal.

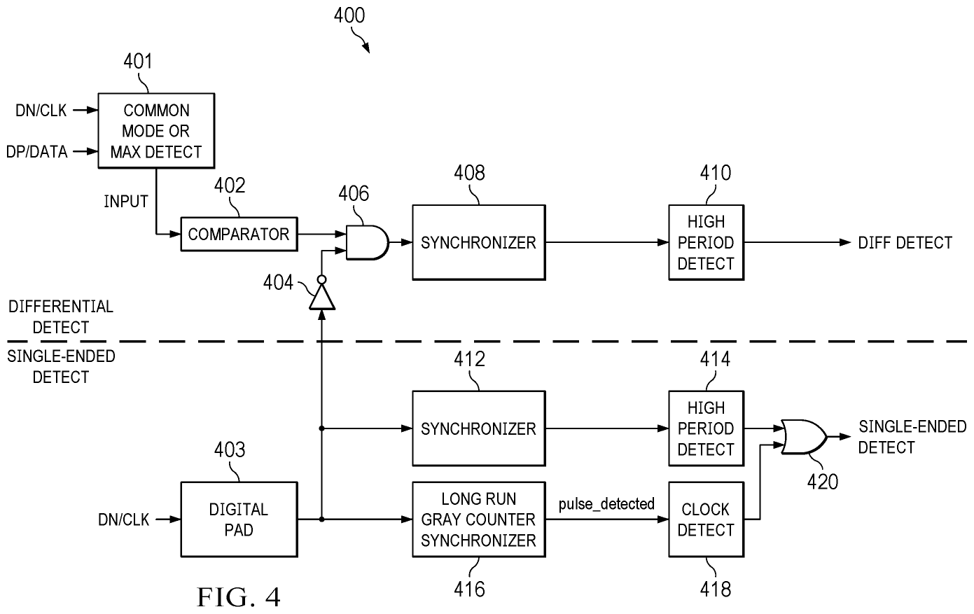

FIG. 4 illustrates a block diagram of an example subsystem 400 for detection of signal presence and signaling type, in accordance with embodiments of the present disclosure. Subsystem 400 may be implemented by any suitable component of a device 102, including without limitation a PHY 116 and/or one or more components of a PHY 116 (e.g., receiver 210 and/or receiver 214). Subsystem 400 may include a portion for detection of differential signaling, such portion including a common-mode or maximum detector 401, an analog comparator 402, a digital pad 403, a logical inverter 404, a logical AND gate 406, a synchronizer 408, and a high period detector 410.

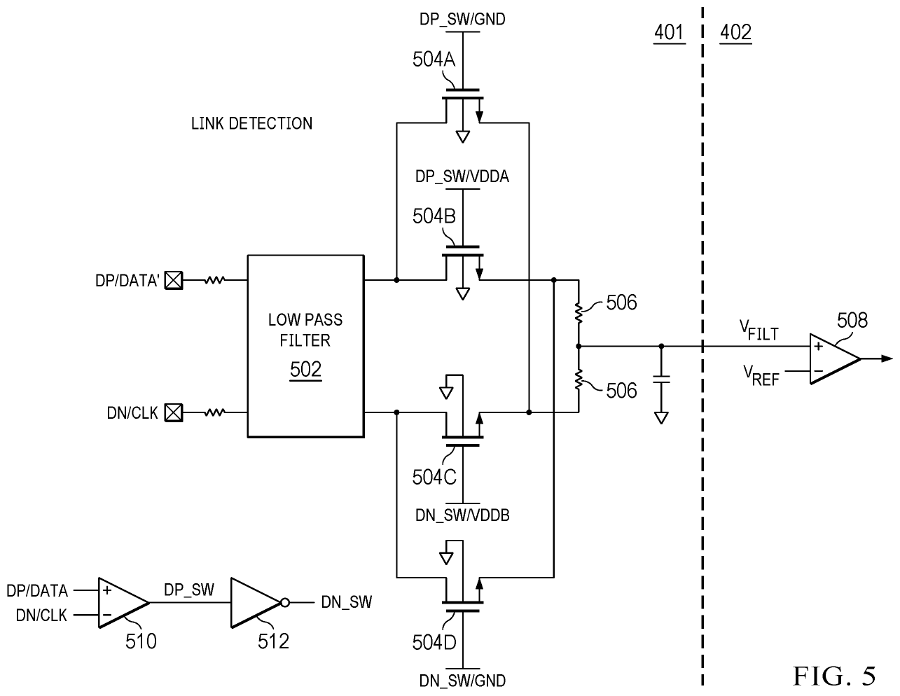

Common-mode or maximum detector 401 may receive signal line DN/CLK and signal line DP/DATA and detect either a common-mode or a maximum of the signals on such signal lines, to generate an input signal INPUT. Analog comparator 402 may receive and compare input signal INPUT to a threshold voltage, asserting (e.g., generating output of logical “1”) a digital signal indicative if such threshold is exceeded or deasserting the digital signal (e.g., generating output of logical “0”) if such threshold is not exceeded by the voltage present on input signal INPUT. Such threshold voltage may be such that if a signal is present on input signal INPUT, the voltage on input signal INPUT exceeds the threshold voltage in order that analog comparator 402 may assert a digital signal indicating the voltage on input signal INPUT exceeds the threshold, and otherwise deassert the digital signal to indicate the voltage on input signal INPUT is less than the threshold. An example implementation of common-mode or maximum detector 401 and analog comparator 402 is described in greater detail below with reference to FIG. 5.

While a voltage present on input signal INPUT below the threshold voltage of analog comparator 402 may indicate the absence of a signal, the condition of the voltage present on input signal INPUT may indicate the presence of a signal that possibly, but not necessarily, is a differential signal. To determine whether the threshold-exceeding signal is indicative of a differential signal, as shown in FIG. 3B, instead of a single-ended signal as shown in FIG. 3C, masking logic comprising inverter 404 and logical AND gate 406 may be employed.

Digital pad 403 may comprise any suitable system, device, or apparatus configured to convert the analog signal on signal line DN/CLK into digital logic levels. Inverter 404 and logical AND gate 406 may operate to mask the output of analog comparator 402 when the voltage present on signal line DN/CLK is much higher than expected common-mode voltage V_{CM}, in which case inverter 404 and logical AND gate 406 may deassert the output of logical AND gate 406,

Synchronizer 408 may comprise any suitable system, device, or apparatus configured to, as is known in the art, synchronize an asynchronous signal to a clock or synchronize a signal from one clock domain to another clock domain.

High period detector 410 may comprise any suitable system, device, or apparatus configured to detect whether the output of synchronizer 408 remains asserted for a minimum period of time or minimum period of clock cycles. Accordingly, high period detector 410 ensures that the signal present on input signal INPUT is not an oscillating clock signal that may be present on input signal INPUT during single-ended signaling, such as what is shown in FIG. 3C when traffic is present. Thus, high period detector 410 may assert differential detection signal DIFFDETECT if a high period assertion is detected at the output of synchronizer 408, and deassert differential detection signal DIFFDETECT otherwise.

Subsystem 400 may include a portion for detection of single-ended signaling, such portion including synchronizer 412, high period detector 414, long run Gray counter synchronizer 416, clock detector 418, and logical OR gate 420. Synchronizer 412 may comprise any suitable system, device, or apparatus configured to, as is known in the art, synchronize an asynchronous signal to a clock or synchronize a signal from one clock domain to another clock domain.

High period detector 414 may comprise any suitable system, device, or apparatus configured to detect whether the output of synchronizer 412 remains asserted for a minimum period of time or minimum period of clock cycles. Accordingly, high period detector 414 may determine if the signal present on signal line DN/CLK is a long pulse indicative of single-ended signaling in the absence of traffic as shown FIG. 3C. Thus, high period detector 410 may assert its output if a high period of an asserted signal (e.g., logical “1”) is detected at the output of synchronizer 412, and deassert its output otherwise.

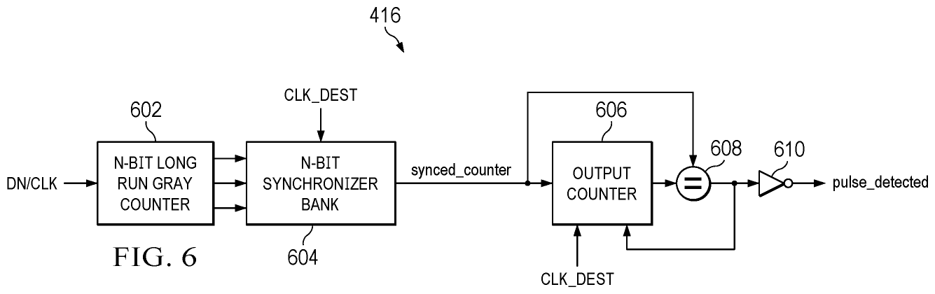

Long run Gray counter synchronizer 416 may comprise a synchronizer that utilizes a modified Gray code counter to count clocks and transfer the count to the destination clock domain. In particular, long run Gray counter synchronizer 416 may enable subsystem 400 to, without a system clock (e.g., due to device 102 being in a sleep or low-power state), detect the initial part of detecting clock pulses present on signal line DN/CLK in the presence of traffic during signal ended signaling as shown in FIG. 3C. An example implementation of long run Gray counter synchronizer 416 is described in greater detail below with reference to FIG. 6. As shown in FIG. 4, long run Gray counter synchronizer 416 may assert a signal PULSE_DETECTED for one cycle indicating a pulse on input signal INPUT.

Clock detector 418 may comprise any suitable system, device, or apparatus configured to analyze signal PULSE_DETECTED to determine if the detected pulse is indicative of a periodic pulse associated with single-ended signaling in the presence of traffic (e.g., a minimum number of clock pulses present on signal line DN/CLK). Thus, clock detector 418 may assert its output if a high period of a clock signal is detected and deassert its output otherwise.

Logical OR gate 420 may assert a single-ended detection signal SINGLE-ENDED DETECT if either of the outputs of high period detector 414 or clock detector 418 are asserted to indicate presence of single-ended signaling of the communications link, and deassert single-ended detection signal SINGLE-ENDED DETECT otherwise.

Accordingly, subsystem 400 may be configured to detect the presence or absence of signaling based on signal properties (e.g., voltage) of a signal link and detect a signaling type based on signal properties (e.g., voltage, periodicity).

In some embodiments, the presence and signaling type may be used by a processor 112 of PHY 116 to wake a device 102 from a low-power or sleep state.

FIG. 5 illustrates a circuit diagram of an example common-mode or maximum detector 401 with analog comparator 402 for detection of signal presence, in accordance with embodiments of the present disclosure. As shown in FIG. 5, common-mode or maximum detector 401 may include a low-pass filter 502, a switching circuit comprising switches 504 (e.g., switches 504A, 504B, 504C, and 504D), and a resistor divider comprising resistors 506 each having approximately the same resistance, arranged as shown. Analog comparator 402 may be implemented by an output comparator 508 coupled to an output of common-mode or maximum detector 401.

Low-pass filter 502 may comprise any system, device, or apparatus configured to perform low pass filtering of the voltages present on signal lines DP/DATA and DN/CLK. Low-pass filter 502 may be a filter of any suitable order (e.g., third-order).

Switches 504 may be controlled in order to place common-mode or maximum detector 401 into either a max voltage detection mode (a high-power mode) or a common-mode voltage detection mode (a lower-power mode). In the max voltage detection mode, switches 504A and 504B may be selectively enabled or disabled by a switching control signal DP_SW while switches 504C and 504D may be selectively enabled or disabled by a switching control signal DN_SW. The circuit for common-mode or maximum detector 401 may include a fast comparator 510 that compares the voltages on signal lines DP/DATA and DN/CLK, and may assert switching control signal DP_SW and deassert (e.g., via logic inverter 512) switching control signal DN_SW when the voltage on signal line DP/DATA is greater than the voltage on signal line DN/CLK, and may deassert switching control signal DP_SW and assert (e.g., via logic inverter 512) switching control signal DN_SW when the voltage on signal line DN/CLK is greater than the voltage on signal line DP/DATA. Accordingly, in the max voltage detection mode, when the voltage on signal line DP/DATA is greater than the voltage on signal line DN/CLK, a filtered voltage V_{FILT} present at the voltage node common to resistors 506 may be equal to a low-pass filtered version of the voltage on signal line DP/DATA. Likewise, when the voltage on signal line DN/CLK is greater than the voltage on signal line DP/DATA, a filtered voltage V_{FILT} present at the voltage node common to resistors 506 may be equal to a low-pass filtered version of the voltage on signal line DN/CLK. Accordingly, filtered voltage V_{FILT} may be equal to the higher of the two voltages present on signal lines DP/DATA and DN/CLK.

In the common-mode voltage detection mode, switches 504A and 504D may be disabled, and switches 504B and 504C may be enabled. Consequently, in the common-mode voltage detection mode, filtered voltage V_{FILT} may be equal to the common mode voltage of the voltages present on signal lines DP/DATA and DN/CLK.

In both the max voltage detection mode and the common-mode voltage detection mode, comparator 508 may compare filtered voltage V_{FILT} to a reference voltage VREF, assert the output of analog comparator 402 when filtered voltage V_{FILT} is greater than the reference voltage VREF, and otherwise deassert the output of analog comparator 402.

FIG. 6 illustrates a block diagram of an example long run Gray counter synchronizer 416, in accordance with embodiments of the present disclosure. As shown in FIG. 6, long run Gray counter synchronizer 416 may include an N-bit long run Gray counter 602, an N-bit synchronizer bank 604, an output counter 606, a comparator 608, and a logic inverter 610. As shown in FIG. 6, N-bit long run Gray counter 602 may be in a different clock domain (e.g., clocked by signal line DN/CLK) than N-bit synchronizer bank 604 and output counter 606 (e.g., clocked by a destination clock CLK_DEST).

N-bit long run Gray counter 602 may be any suitable digital counter N bits in width that increments in accordance with a special encoding. For example, N-bit long run Gray counter 602 may be implemented with a circular encoding that only one bit may change each time the counter increments, and a bit may not change if it has changed within the last N−1 increments. Accordingly, N-bit long run Gray counter 602 may count from 0 to 2N−1 and back again to 0. For example, the table below sets forth the encoding of N-bit long run Gray counter 602 when N=5, wherein each column of the table includes a header in the top depicting an unencoded counter value, and the remaining rows of such column set forth the N=5 bit encoding for the unencoded counter value.

| 0 | 1 | 2 | 3 | 4 | 5 | 6 | 7 | 8 | 9 | Invalid |
|---|---|---|---|---|---|---|---|---|---|---|
| 0 | 1 | 1 | 1 | 1 | 1 | 0 | 0 | 0 | 0 | All |
| 0 | 0 | 1 | 1 | 1 | 1 | 1 | 0 | 0 | 0 | Others |
| 0 | 0 | 0 | 1 | 1 | 1 | 1 | 1 | 0 | 0 | |
| 0 | 0 | 0 | 0 | 1 | 1 | 1 | 1 | 1 | 0 | |
| 0 | 0 | 0 | 0 | 0 | 1 | 1 | 1 | 1 | 1 | |

N-bit synchronizer bank 604 may comprise any suitable system, device, or apparatus configured to synchronize the various N bits generated by N-bit long run Gray counter 602, which may be asynchronous, to a clock, generating a counter value SYNCED_COUNTER.

Output counter 606 may comprise another long run Gray counter configured to, in concert with comparator 608, increment the output of counter 606 each time the output of counter 606 is not equal to the input of counter 606. As a result, each time the output of counter 606 is not equal to the input of counter 606 may indicate the detection of a pulse of the voltage on signal line DN/CLK. Accordingly, logic inverter 610 may assert signal PULSE_DETETCED each time the output of counter 606 is not equal to the input of counter 606.

As a result, long run Gray counter synchronizer 416 may allow the destination clock domain (e.g., clocked by destination clock CLK_DEST) to have a delay in starting up, which may allow the source clock to send multiple clock edges into long run Gray counter synchronizer 416 that may not be lost while destination clock CLK_DEST is starting up.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A device comprising:
a processor; and
a physical interface communicatively coupled to the processor and configured to communicatively couple to a second device via a wired communication link having a communications protocol comprising a plurality of signaling types, and further configured to:
detect a presence or absence of signaling on the wired communication link based on one or more signal properties of a signal on the wired communication link; and
detect a signaling type, from the plurality of signaling types, of signaling on the wired communication link based on one or more signal properties of the signal on the wired communication link.

2. The device of claim 1, wherein detecting the presence or absence of signaling on the wired communication link is based on a magnitude of the signal on the wired communication link.

3. The device of claim 1, wherein detecting the signaling type of signaling on the wired communication link is based on a magnitude of the signal on the wired communication link and a periodicity of the signal on the wired communication link.

4. The device of claim 1, wherein the signaling type comprises single-ended signaling.

5. The device of claim 1, wherein the signaling type comprises differential signaling.

6. The device of claim 1, wherein the wired communication link comprises two signal lines.

7. The device of claim 1, wherein the physical interface is further configured to wake the device from a low-power or sleep state in response to detecting the presence of signaling on the wired communication link.

8. The device of claim 1, wherein the physical interface is configured to begin the detection of signaling on the wired communication link in the absence of a system clock for the device using a Gray counter.

9. The device of claim 1, wherein the plurality of signaling types comprises a first signaling type and a second signaling type, and the physical interface is configured to mask detection of the first signaling type with a clock signal of the second signaling type.

10. The device of claim 1, wherein the physical interface is further configured to detect the signaling type based on a range of magnitude of the signal for a communications protocol-dependent period of time.

11. The device of claim 1, wherein the physical interface is further configured to detect the signaling type based on a detection of a minimum number of clock pulses of the signal.

12. The device of claim 1, wherein:
the wired communication link comprises two signal lines; and
the physical interface is further configured to detect the signaling type based on a magnitude of a common-mode between signals on the two signal lines.

13. The device of claim 1, wherein:
the wired communication link comprises two signal lines; and
the physical interface is further configured to detect the signaling type based on a maximum magnitude between a first signal on a first signal line of the two signal lines and a second signal on a second signal line of the two signal lines.

14. A method comprising:
based on one or more signal properties of a signal on a wired communication link, detecting a presence or absence of signaling on the wired communication link having a communications protocol comprising a plurality of signaling types; and
detecting a signaling type, from the plurality of signaling types, of signaling on the wired communication link based on one or more signal properties of the signal on the wired communication link.

15. The method of claim 14, wherein detecting the presence or absence of signaling on the wired communication link is based on a magnitude of the signal on the wired communication link.

16. The method of claim 14, wherein detecting the signaling type of signaling on the wired communication link is based on a magnitude of the signal on the wired communication link and a periodicity of the signal on the wired communication link.

17. The method of claim 14, wherein the signaling type comprises single-ended signaling.

18. The method of claim 14, wherein the signaling type comprises differential signaling.

19. The method of claim 14, wherein the wired communication link comprises two signal lines.

20. The method of claim 14, further comprising waking a device communicatively coupled to the wired communication link from a low-power or sleep state in response to detecting the presence of signaling on the wired communication link.

21. The method of claim 14, further comprising beginning the detection of signaling on the wired communication link in the absence of a system clock for the device using a Gray counter.

22. The method of claim 14, wherein the plurality of signaling types comprises a first signaling type and a second signaling type, and the physical interface is configured to mask detection of the first signaling type with a clock signal of the second signaling type.

23. The method of claim 14, further comprising detecting the signaling type based on a range of magnitude of the signal for a communications protocol-dependent period of time.

24. The method of claim 14, further comprising detecting the signaling type based on a detection of a minimum number of clock pulses of the signal.

25. The method of claim 14, wherein:
the wired communication link comprises two signal lines; and
the method further comprises detecting the signaling type based on a magnitude of a common-mode between signals on the two signal lines.

26. The method of claim 14, wherein:
the wired communication link comprises two signal lines; and
the method further comprises detecting the signaling type based on a maximum magnitude between a first signal on a first signal line of the two signal lines and a second signal on a second signal line of the two signal lines.
